(19) United States
(12) Patent Application Publication
(10) Pub. No.: US 2011/0217453 A1
(43) Pub. Date: Sep. 8, 2011

(54) MANUFACTURING METHOD OF SUBSTRATE HAVING FUNCTION LAYER BETWEEN PARTITION WALLS, AND MANUFACTURING METHOD OF IMAGE DISPLAY APPARATUS USING THE SUBSTRATE

(75) Inventor: Yoshitaka Ishioka, Koza-gun (JP)

(73) Assignee: CANON KABUSHIKI KAISHA, Tokyo (JP)

(21) Appl. No.: 13/032,136

(22) Filed: Feb. 22, 2011

(30) Foreign Application Priority Data
Mar. 8, 2010 (JP) 2010-050443

(51) Int. Cl. B05D 5/06

(52) U.S. Cl. 427/67

(57) ABSTRACT

The present invention provides a manufacturing method of a display substrate that can easily remove a substance adhering to the top of partition walls with high precision. On a substrate, partition walls for dividing a surface of the substrate into a plurality of regions are formed, and a color filter layer and a light emitting layer are formed in the regions. Then, a water solvable polymer layer is deposited at the top of the partition walls, and a planarized layer is formed on the light emitting layer. Then, the water solvable polymer layer formed on the top of the partition walls is removed by water rinsing to remove a substance adhering to the top of the partition walls.

### BACKGROUND OF THE INVENTION

1. Field of the Invention

The present invention relates to a manufacturing method of a display substrate having a function layer, such as a light emitting layer for emitting a light responsive to electron bombardment, in a plurality of regions divided by a partition wall, and a manufacturing method of an image display apparatus using the display substrate.

2. Description of the Related Art

A plasma display (PDP) and a field emission display (FED) known as a flat panel display have partition walls in the internal structure, and function layers are formed in a plurality of regions divided by the partition walls. For example, in the PDP, an electrode layer, an insulating layer and a phosphor layer are formed in the regions divided by the partition walls, and in the FED a pigment layer, a phosphor layer and a planarized layer are formed in the regions divided by the partition walls. When these function layers are formed, generally, a method for dropping pastes including the constituent materials of the function layers by a screen printing method is often used.

However, due to a change in the shape of the screen plate over time, the paste may adhere to the top of the partition wall. When this paste adhesion occurs, the adhesiveness of a forming material, such as a metal back, laminated on the top of the partition walls to the partition walls decreases, and the peeling of the metal back and pattern failure may occur. In addition, when one of the pigment and the phosphor adheres to the top of the partition wall, and one of the pigment and the phosphor adhering peels and falls in the next region beyond the partition wall, color mixing (cross-talk) during image display is induced.

Japanese Patent Application Laid-Open No. 2004-319460 discloses a method for allowing a substance adhering to the top of partition walls to adhere a tacky body for removal, as a method for removing an unnecessary substance adhering to the top of partition walls. In addition, Japanese Patent Application Laid-Open No. H6-96673 discloses a method for forming a non-water-solvable resist film on the top of partition walls and removing a substance adhering together with a resist film by lift-off using an organic solvent.

However, in a method for removing a substance adhering to the top of partition walls, using the tackiness of a tacky body, as in Japanese Patent Application Laid-Open No. 2004-319460, it is necessary to surely adhere the tacky body to the top of the partition walls and further surely peel the tacky body. But, if the tackiness of the tacky body is insufficient, the removal efficiency of the substance adhering decreases. If the tackiness is excessive, the tackifier is transferred to the top of the partition walls and remains. Therefore, it cannot be said that the effect of removing the substance adhering is sufficient.

In addition, in a method for covering the top of partition walls with a resist film, as in Japanese Patent Application Laid-Open No. H6-96673, when an attempt is made to form a uniform resist film, the height of the partition walls are limited. In addition, a resist peeling liquid, such as acetone, is used in lift-off using the resist film, and therefore, the resin components of the function layers formed between the partition walls are dissolved, and the surface coarsed and the nonuniformity of film thickness due to pattern peeling and film reduction may occur.

In view of the above problems, it is an object of the present invention to, during the manufacturing process of a display substrate having a partition wall, remove an unnecessary substance adhering to the top of the partition wall easily and efficiently to easily provide a display substrate with high precision. It is another object of the present invention to provide an image display apparatus with high display characteristics, using such a display substrate.

### SUMMARY OF THE INVENTION

According to a second aspect of the present invention, a manufacturing method of an image display apparatus comprises an electron emitting substrate having at least a first substrate, a plurality of electron-emitting devices arranged on the substrate and a wiring for applying a voltage to the electron-emitting device; a display substrate arranged in opposition to the electron emitting substrate, and having at least a second substrate, a partition wall for dividing a surface of the second substrate into a plurality of regions and a light emitting layer arranged in the region for emitting a light responsive to an bombardment by an electron emitted from the electron-emitting device; and a frame arranged in a peripheral region of the electron emitting substrate and the display substrate between a pair of said substrates, wherein the display substrate is manufactured by the manufacturing method according to the above manufacturing method of the display substrate.

According to the present invention, the function layers are formed after the water solvable polymer layer is formed on the top of the partition walls, and the unnecessary substance adhering to the top of the partition walls is removed together with the water solvable polymer layer by water rinsing. Thus, the unnecessary substance adhering to the top of the partition walls can be removed without affecting the function layers formed between the partition walls, and adverse effects, for example, the adhesion decrease of a member, such as a wiring, formed on the top of the partition walls in a subsequent step, can be prevented. Therefore, a display substrate with high reliability, and an image display apparatus with excellent display characteristics can be easily provided with good precision.

Further features of the present invention will become apparent from the following description of exemplary embodiments with reference to the attached drawings.

### BRIEF DESCRIPTION OF THE DRAWINGS

FIGS. 1A, 1B, 1C, 1D, 1E, 1F, 1G, and 1H are cross-sectional schematic diagrams illustrating steps of one example of a manufacturing method of a display substrate according to the present invention.

FIGS. 2A and 2B are schematic diagrams illustrating the image display apparatus of the present invention and an electron emitting substrate used in the image display apparatus.

### DESCRIPTION OF THE EMBODIMENTS

Preferred embodiments of the present invention will now be described in detail in accordance with the accompanying drawings.

Embodiments of the present invention will be described below in detail with reference to the drawings. Techniques well known or publicly known in the art can be applied to portions not particularly illustrated or described.

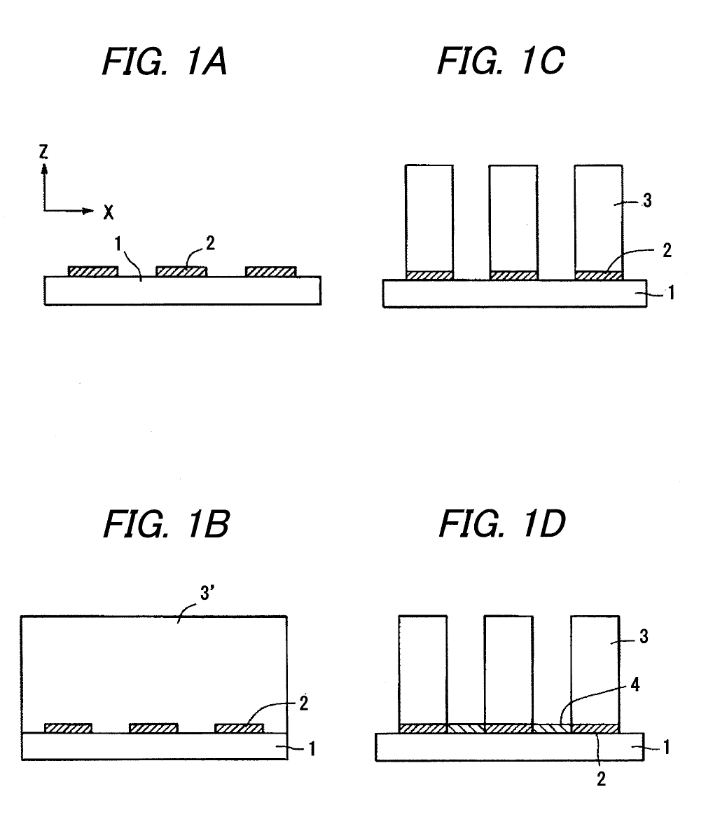

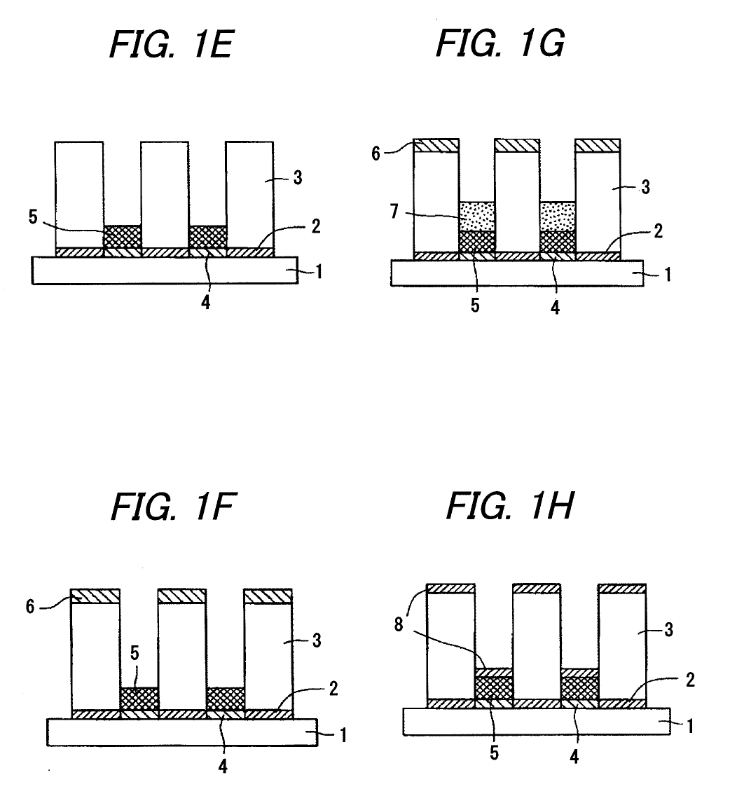

FIGS. 1A to 1H are the step diagrams of one example of a manufacturing method of a display substrate according to the present invention, and illustrates an example of the manufacturing of the face plate of a field emission display (FED). As illustrated in FIG. 1H, in the display substrate in this example, a substrate surface is divided into a plurality of regions by partition walls 3 formed on a substrate 1. The display substrate has a color filter layer 4, a light emitting layer 5 and a metal back 8 as function layers in each region. In addition, the metal back 8 is also formed on the partition walls 3, and a light shielding layer 2 is formed between the partition walls 3 and the substrate 1.

In the present invention, the function layers are layers having predetermined functions, formed in the regions divided by the partition walls on the substrate, and include not only the constituent members of the final display substrate, but also layers formed in the regions and then removed during the manufacturing process. In this example, after the light emitting layer 5 is formed, and before the metal back 8 is formed, a planarized layer 7 for planarizing a surface of the light emitting layer 5 is formed as a function layer. Such a planarized layer 7 is removed by baking after the metal back 8 is formed, as described later. If the forming material of the planarized layer 7 adheres to the top of the partition walls 3, the adhesivity between the metal back 8 and the partition walls 3 decreases. Therefore, it is desired that the planarized layer 7 is removed. In this example, a case where a water solvable polymer layer 6 is formed on the top of the partition walls 3, prior to the step of forming the planarized layer 7 using a paste, will be described below as an example.

First, as illustrated in FIG. 1A, the light shielding layer 2 is formed on the substrate 1, using, for example, screen printing. The substrate 1 is not particularly limited, and, for example, one of general soda lime glass, a glass substrate obtained by annealing soda lime glass, and a high strain point glass substrate can be used. As the light shielding layer 2, for example, a black matrix structure publicly known for a CRT and the like is used, but the light shielding layer 2 is not limited to the black matrix structure. A black matrix is generally made of one of a black metal, a black metal oxide, carbon and the like. Examples of the black metal oxide include ruthenium oxide, chromium oxide, iron oxide, nickel oxide, molybdenum oxide, cobalt oxide or copper oxide.

Next, as illustrated in FIG. 1B, a material 3′ forming the partition walls 3 is deposited on the substrate having the above light shielding layer 2, using, for example, a slit coating method. For the partition wall material 3′, for example, materials of inorganic mixtures having resistance close to insulation, like glass materials including metal oxides, such as lead oxide, zinc oxide, bismuth oxide, boron oxide, aluminum oxide, silicon oxide and titanium oxide, can be used. After the partition wall material 3′ is deposited and dried, the partition wall material is patterned to form the partition walls 3 on the light shielding layer 2, as illustrated in FIG. 1C. For the patterning of the partition walls 3, for example, a sandblasting method, a photosensitive photopaste method and an etching method can be used, but the patterning is not limited to these methods. The height of the partition walls 3 is appropriately set according to the specifications of the image display apparatus. In this example, the partition walls 3 are formed in stripes along the Y direction.

Next, as illustrated in FIG. 1D, the color filter layer 4 for adjusting light transmittance is formed between the partition walls. For the materials of the color filter layer 4, for example, pastes in which fine particles of Fe₂O₃ as red, Co(Al.Cr)₂O₄ and (Co, Ni, Zn)₂TiO₄ as green, and Al₂O₃.CoO as blue are respectively dispersed can be used. The respective pastes are deposited on predetermined regions, dried and baked to form the color filter layer 4. In this example, the color filter layer 4 is arranged in the regions between the partition walls. But, for color display, at least the light emitting layer 5 corresponding to the colors of R, G and B may be present, and a structure in which the color filter layer 4 is not arranged may be used.

After the color filter layer 4 is formed, the light emitting layer 5 is formed on the color filter layer 4, as illustrated in FIG. 1E. As the light emitting layer 5, for example, phosphor crystals that emit a light responsive to electron beam excitation can be used. Specific materials of the phosphors can be selected correspondingly to the colors of R, G and B, for example, from phosphor materials publicly known in the field of CRTs described in “Phosphor Handbook,” edited by Keikoutai Dougakukai (published by Ohmsha, Ltd.). The light emitting layer 5 can be formed by depositing, drying and baking pastes in which phosphor materials are dispersed, as in the formation of the color filter layer 4. Then, the substrate surface is uniformly spray-coated, for example, with a solution including alkali silicate, the so-called water glass, as a binder, and dried to adhere the light emitting layer 5 to the substrate.

Next, as illustrated in FIG. 1F, a water solvable resin solution is deposited at the top of the partition walls 3, using, for example, one of a screen printing method, a dispenser method, and the like, and dried to form the water solvable polymer layer 6. The film thickness of the water solvable polymer layer 6 formed on the top of the partition walls 3 can be in the range of 5 to 15 μm in terms of dry film thickness. As the water solvable resin forming the water solvable polymer layer 6, basically, a water solvable resin that can form a resin film having solvent resistance can be used without particular limitation. Specific examples of the water solvable resin can include cellulose-based water solvable resins, such as carboxymethyl cellulose, and vinyl-based water solvable resins, such as polyvinyl alcohol, and in addition, acryl-based water solvable resins including polyacrylamide, N,N-dimethylacrylamide, N,N-dimethylaminopropylacrylamide, N-methylacrylamide, diacetoneacrylamide and the like as a monomer.

Particularly, polyvinyl alcohol can be used. These water solvable resins may be used alone, or two or more of the resins may be used in combination. The polyvinyl alcohol can be polyvinyl alcohol having a degree of polymerization in the range of 300 to 2700 and a degree of saponification in the range of 80 to 95 mole %. The water solvable resin solution can be an aqueous solution in the range of 5 to 20% by mass. In addition, the drying temperature in forming the water solvable polymer layer 6 can be in the range of 80 to 100° C. If the drying temperature is more than 100° C., the water solvable polymer layer 6 may alter, and therefore, such drying temperature is unfavorable.

Next, as illustrated in FIG. 1G, the planarized layer 7 is deposited on the light emitting layer 5 in order to form the metal back 8 flat. As the forming material of the planarized layer 7, for example, a resin paste obtained by diluting a resin, such as acryl and ethyl cellulose, with an organic solvent, such as terpineol and butyl carbitol acetate, can be used. By depositing and drying such a paste, the gaps in the light emitting layer 5 are filled with the planarized layer 7 to planarize the surface.

Next, the water solvable polymer layer 6 formed on the top of the partition walls 3 is removed, for example, by water rinsing. Specifically, the water solvable polymer layer 6 can be removed by spraying hot water at 25 to 60° C. like a shower. At this time, the unnecessary substance adhering to the water solvable polymer layer 6 (the forming material paste of the planarized layer 7) is removed together with the water solvable polymer layer 6.

Next, as illustrated in FIG. 1H, the metal back 8 is formed using a filming method publicly known in the field of CRTs, and then, the substrate is baked in the air to burn off the planarized layer 7. In this example, the metal back 8 is formed on the partition walls 3 and the light emitting layer 5, but it is possible to laminate a dry film resist on portions corresponding to the phosphors, which are the light emitting layer 5, for patterning, and form the metal back 8 only on the light emitting layer 5. In this example, the forming material of the planarized layer 7 adhering to the top of the partition walls 3 is removed together with the water solvable polymer layer 6, and therefore, good contact is achieved between the top and the member in contact with the top. When the metal back 8 is also formed on the top of the partition walls 3, as illustrated in FIG. 1H, the adhesion of the metal back 8 to the top is high, and problems, such as peeling, are prevented.

As described above, in this example, the water solvable polymer layer 6 is formed on the top of the partition walls 3, the planarized layer 7 is formed using the paste, and then, the water solvable polymer layer 6 is removed by water rinsing to remove the unnecessary substance adhering to the top of the partition walls together with the water solvable polymer layer 6. Thus, the unnecessary substance adhering to the top of the partition walls can be removed easily and efficiently, without affecting the function layers formed between the partition walls 3, and there is no effect of the unnecessary substance adhering to the top of the partition walls in the subsequent steps. Therefore, the display substrate can be easily manufactured with high precision.

An exemplary embodiment of the present invention has been described above, but the present invention can be carried out in various modes different from the above embodiment without departing from the spirit of the present invention. For example, in the above embodiment, the water solvable polymer layer 6 is formed on the top of the partition walls 3 before the formation of the planarized layer 7, one of the function layers, but the present invention is not limited to this. In the present invention, the formation step of the water solvable polymer layer may be before the formation step of any function layer, as long as the formation step of the water solvable polymer layer is before the formation step using the paste. For example, the water solvable polymer layer 6 may be formed on the top of the partition walls 3 before the formation of the color filter layer 4, or before the formation of the light emitting layer 5. In this case, the removal of the water solvable polymer layer 6 by water rinsing may be any of after the formation of the color filter layer 4, after the formation of the light emitting layer 5, and after the formation of the planarized layer 7, but the water solvable polymer layer 6 can be removed after the formation of the planarized layer 7.

In addition, in the above embodiment, the partition walls 3 are formed in stripes along the Y direction, but the partition walls 3 may be formed not only in the Y direction only, but also in the X direction only, or the partition walls 3 may be formed like a grid, both in the X direction and the Y direction.

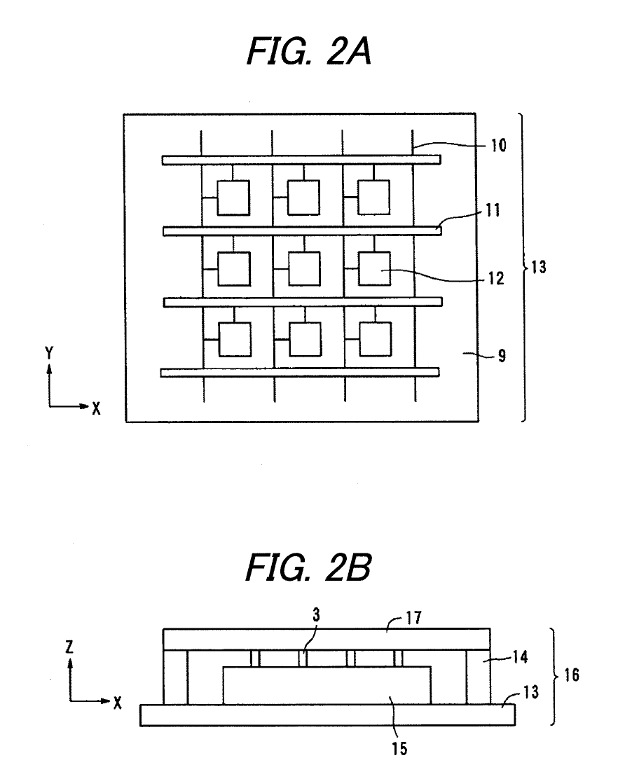

Next, an image display apparatus 16 formed using the display substrate 17 of the present invention fabricated as described above will be described with reference to FIGS. 2A and 2B. FIG. 2A is a plan view illustrating an electron emitting substrate used in the image display apparatus of the present invention. FIG. 2B is a schematic diagram illustrating the cross-sectional structure of one example of the image display apparatus of the present invention.

An electron emitting substrate 13 used in the present invention has a plurality of electron-emitting devices 12 on a substrate 9, as illustrated in FIG. 2A. The devices 12 are connected to a matrix wiring including signal lines 10 and scan lines 11 so that electron emission from a predetermined address is controlled by a drive circuit not illustrated. The electron-emitting device 12 is not particularly limited, and, for example, a surface conduction type electron-emitting device can be used.

The display apparatus 16 in this example is fabricated by forming a vacuum container in which the electron emitting substrate 13 having the electron-emitting devices 12 is arranged in opposition to the display substrate 17, and a frame 14 is arranged between the substrates in a peripheral portion thereof, as illustrated in FIG. 2B. The display substrate of the present invention having at least a substrate, a partition wall for dividing a surface of the substrate into a plurality of regions, and a light emitting layer arranged in the regions divided by the partition wall, obtained by the above-described manufacturing method, is used as the display substrate 17. In FIG. 2B, only the partition walls 3, characteristic structures of such a display substrate, are illustrated, and other members are omitted for convenience. Here, a spacer 15 is provided within the display apparatus formed as the vacuum container for atmospheric pressure resistant retention to abut the top of the partition walls 3 of the above display substrate 17. A high pressure voltage is applied from a high pressure power supply, not illustrated, to the electron emitting substrate 13, and the light emitting layer of the display substrate 17 is bombarded with electrons emitted from the electron emitting substrate 13 to emit a light.

An exemplary embodiment of the present invention has been described above, but the present invention can be carried out in various modes different from the above embodiment without departing from the spirit of the present invention.

The manufacturing method of a display substrate according to the present invention will be described below in more detail by giving Example, but the present invention is not limited to this Example.

### Example 1

Based on the manufacturing method of a display substrate exemplified in FIGS. 1A to 1H, a display substrate is manufactured by the following steps.

(Step 1: Formation of Light Shielding Layer 2)

A black paste (NP-7811M1, manufactured by NORITAKE CO., LIMITED) was printed on an entire surface of the glass substrate 1 washed. This substrate 1 was dried at 150° C., then exposed at 1000 mJ/cm², developed, and baked at 580° C. to form the light shielding layer 2 having a thickness of 5 μm and having openings with a horizontal pitch of 210 μm, a vertical pitch of 630 μm, and an opening size of 150×200 μm.

(Step 2: Formation of Partition Walls 3)

An insulating paste obtained by adding alumina having an average particle diameter of about 5 μm to borosilicate glass was deposited on the center lines between the 210 μm pitches of the pixels of the light shielding layer 2 by a slit coater. This substrate was dried at 95° C., then exposed at 300 mJ/cm², developed, and baked at 580° C. to form the stripe-shaped partition walls 3 having a thickness of 200 μm and a width of 55 μm.

(Step 3: Formation of Color Filter Layer 4)

Next, pastes in which pigments were dispersed, as color filter materials, were dropped and printed by a screen printing method, according to the gaps between the stripe-shaped partition walls 3, subjected to drying treatment at 110° C., and then baked at 500° C. to form the color filter layer 4. In this example, the pastes were separately deposited in stripes of three colors of R, G and B to provide a color display, and the film thickness was 2 μm. The drying treatment of the color filter layer 4 may be performed for each color or may be collectively performed for three colors.

(Step 4: Formation of Light Emitting Layer 5)

Next, pastes in which P22 phosphors used in the field of CRTs were dispersed, as the forming material of the light emitting layer 5, were dropped and printed by a screen printing method, according to the gaps between the stripe-shaped partition walls 3. Then, the phosphors of three colors were subjected to drying treatment at 110° C., further baked at 500° C., and then, spray-coated with an aqueous solution including alkali silicate, the so-called water glass, acting as a binder. In this example, the phosphors of three colors of R, G and B were separately deposited in stripes to provide a color display, and the film thickness was 10 μm. The drying treatment of the phosphors may be performed for each color or may be collectively performed for three colors.

(Step 5: Formation of Water Solvable Polymer Layer 6)

Carboxymethyl cellulose as the water solvable polymer layer 6 was printed on the top of the partition walls 3, using a pattern printing plate, and subjected to drying treatment at 90° C. The film thickness of the water solvable polymer layer 6 after the drying was 10.3 μm.

(Step 6: Formation of Planarized Layer 7)

Next, ethyl cellulose as the forming material of the planarized layer 7 was dropped and printed on the light emitting layer 5 between the partition walls 3 by a printing method, and dried at 110° C. to fill the gaps in the phosphor powders constituting the light emitting layer 5 with the ethyl cellulose resin. Then, water rinsing treatment was performed to remove the water solvable polymer layer 6 formed on the top of the partition walls 3. At this time, the ethyl cellulose, the unnecessary substance, adhering to the water solvable polymer layer 6 was removed together with the water solvable polymer layer 6.

(Step 7: Formation of Metal Back 8)

Next, an aluminum film as the metal back 8 was formed on the planarized layer 7 by a vacuum deposition method. At this time, a dry film resist was laminated and patterned, and the metal back 8 was formed only on portions corresponding to the phosphors, the light emitting layer 5. The thickness of the aluminum film, the metal back 8, was 100 nm. Further, this substrate was baked at 500° C. to remove the planarized layer 7.

In this example, the forming material of the planarized layer 7 adhering to the top of the partition walls 3 was removed together with the water solvable polymer layer 6, and in the display using the display substrate, the top of the partition walls 3 and the member in contact with the top are in good contact, and a display with high reliability is formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-050443, filed Mar. 8, 2010, which is hereby incorporated by reference herein in its entirety.

1. A manufacturing method of a display substrate comprising steps of:
forming, on a substrate, a partition wall for dividing a surface of the substrate into a plurality of regions; and
depositing, on the region, a paste for forming a function layer, wherein the manufacturing method further comprises steps of:
depositing a water solvable polymer layer at a top of the partition wall, prior to the step of forming the function layer; and
removing, by water rising, the water solvable polymer layer formed on the top of the partition wall, to remove a substance adhering the water solvable polymer layer together with the water solvable polymer layer.

2. A manufacturing method of an image display apparatus comprising:
an electron emitting substrate having at least a first substrate, a plurality of electron-emitting devices arranged on the first substrate and a wiring for applying a voltage to the electron-emitting device;
a display substrate arranged in opposition to the electron emitting substrate, and having at least a second substrate, a partition wall for dividing a surface of the second substrate into a plurality of regions and a light emitting layer arranged in the region for emitting a light responsive to an bombardment by an electron emitted from the electron-emitting device; and
a frame arranged in a peripheral region of the electron emitting substrate and the display substrate between the electron emitting substrate and the display substrate, wherein
the display substrate is manufactured by the manufacturing method according to claim 1.
